(19) United States
(12) Patent Application Publication
(10) Pub. No.: US 2012/0191510 A1
(43) Pub. Date: Jul. 26, 2012

(54) Music Portal System

(76) Inventor: Alexander Cameron, Winters, CA (US)

(21) Appl. No.: 13/194,907

(22) Filed: Jul. 29, 2011

Related U.S. Application Data
(60) Provisional application No. 61/369,164, filed on Jul. 30, 2010.

(51) Int. Cl. G06Q 30/06; G07C 13/00

(52) U.S. Cl. 705/12; 705/26.61

(57) ABSTRACT

Embodiments of system and method are described that may be used for providing an enhanced live music experience to at least one user in real time. In particular, the embodiments comprise at least one electronic device associated with the at least one user, a web portal and a web server associated with the web portal. The web server utilizes Global Positioning System (GPS) data and timestamps to determine location and login time of the at least one user. The web portal allows the at least one user to instantaneously tag the at least one track which is automatically time coded by the web portal. After crosschecking the user's location and time with a concert database, the web server sends a confirmation message including a link of the at least one track tagged to the at least one user. The at least user may access the link in future to preview, purchase and download the at least one track tagged.

### RELATED APPLICATION

This application claims priority from the U.S. provisional application having Ser. No. 61/369,164, and which was filed on Jul. 30, 2010. The disclosure of that provisional application is incorporated herein by reference as if set out in full.

### BACKGROUND OF THE INVENTION

1. Technical Field of the Invention

The present invention relates in general to systems and methods for providing a live music experience to users. More specifically, the present invention relates to a system and method for providing an enhanced means of delivering data related to a live music experience to users in real-time.

2. Description of the Related Art

The personal music listening experience has been fundamentally enhanced through the introduction of various music portals. These music portals have been greatly expanded over the last ten years through rapid advances in the Internet and World Wide Web. Traditional music portal systems allow the individual to download or play music from a number of Internet websites. This provides an unprecedented choice in music selection.

One of the most powerful ways a user can experience his or her favorite music is at a live concert. However, a major drawback to attending a live concert is that the experience is short lived and passive. If a user wants to purchase or download tracks performed at a live concert, the user must know either the name of the track or the band name. While attending a live concert with many bands, the user does not always know the song's title being played, or the name of the performing band. Additionally, it is music new to the listener that is more likely to be sought after. That is, the very music about which the user knows the least about. Live concerts currently lack the capability to provide purchase or download options to the concert attendee.

Conventionally, one means through which a user may obtain the music from a concert is by obtaining a recording of the concert. Conventional systems for recording generally comprise an event capture module, an editing module and a media-recording module to record the live event onto a plurality of recording media. These recordings can be provided to the attendees of the event shortly after the event has ended. One downside to this system is that it is often very difficult for recording companies to accurately gauge an appropriate level of production relative to the predicted demand, resulting in revenue loss.

There are several other conventional systems to sell and distribute the recordings of live concerts, some including steps taken prior to the live concert being conducted and recorded, or before another specified cut-off date. Such systems allow the event ticket purchaser to pre-purchase one or more copies of a recording of the live performance at a point of sale of tickets. In these systems the concertgoer pre-purchases the recordings even before the live concert occurs. This helps the recording company to calculate the appropriate amount of production relative to the pre-purchase statistics. However, this method does not provide a means for the purchaser to select the recordings of a particular track or a specific band.

Hence, it can be seen that there is a need for a web-based interactive music portal system that would provide a means to a plurality of users to have an enhanced live music experience. Such a system would need to provide a means for the user to extend, relive and share his or her concert experience interactively with friends in real-time. Further, the system would allow the user to tag music tracks in real-time to preview, purchase or download the tagged tracks utilizing a web portal. This system would allow the user to share the purchased track with his/her friends. In addition, this system would provide a map of the venue and the upcoming shows of the artists to the user.

### SUMMARY OF THE INVENTION

The present invention provides an interactive music portal system for providing an enhanced live music experience to at least one user in real time.

The present invention provides an interactive music portal system that comprises at least one electronic device associated with at least one user, a web portal configured to include a plurality of web pages and a web server associated with the web portal. The at least one electronic device is capable of accessing a web browser and the web server is configured to include a database of music concerts. The at least one user utilizes the web browser to access the web portal. The at least one user is given a register/login option to log into the web portal utilizing a username and a password. The web server utilizes Global Positioning System (GPS) data to determine the location of the at least one user. The login time of the at least one user is determined utilizing timestamps. Based on the GPS data and the timestamps, the web portal is able to determine which concert is being performed for the at least one user. The web server compares the location and the login time of the at least one user with the database of music concerts to determine the at least one track attended by the at least one user in real time. The web portal allows the at least one user to instantaneously tag the at least one track for future actions. The at least one track tagged is automatically time coded by the web portal so the system may determine which track the at least one user wants to tag. The web server sends a confirmation message to the at least one electronic device. The confirmation message includes a link of the at least one track tagged by the at least one user. The at least user may access the link in future to preview, purchase and download the at least one track tagged.

In another aspect of the present invention, a method in accordance with the present invention is a method for providing an interactive means for the at least one user to instantaneously tag at least one track in real time.

It is a first objective of the present invention to provide an interactive music portal system that allows the at least one user to instantaneously tag the at least one track of at least one music concert in real time.

It is a second objective of the invention to provide a system that allows the at least one user to communicate with friends present at the at least one music concert in real time.

It is a third objective of the invention to provide a method for the at least one user to extend, relive and share the enhanced live music experience with friends in real time.

Yet another objective of the invention is to provide a system that allows the at least one user to vote for encore to the at least one track in real time.

Still another objective of the invention is to provide an interactive music portal system that allows the at least one user to view upcoming music concerts and venue of the at least one music concert in real-time.

Yet another objective is to determine which tracks at a concert (or festival) were most popular (or tagged) and make that information accessible to those users accessing the system after the performance—thereby informing their selection decisions.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

The foregoing aspects and many of the attendant advantages of the invention will become more readily appreciated as the same becomes better understood by reference to the following detailed description, when taken in conjunction with the accompanying drawings, wherein:

FIG. 1 is a schematic diagram of an interactive music portal system for providing an enhanced live music experience to at least one user in real time;

FIG. 2 is an operational flow chart of a method for providing an interactive means for the at least one user to instantaneously tag at least one track in real time;

FIG. 3 illustrates the at least one electronic device displaying a login page of a web portal in accordance with the preferred embodiment of the present invention;

FIG. 4 illustrates the at least one electronic device displaying a list of music concerts to be selected by the at least one user in accordance with the preferred embodiment of the present invention;

FIG. 5 illustrates the at least one electronic device displaying the at least one track to be tagged by the at least one user in accordance with the preferred embodiment of the present invention;

FIG. 6 illustrates the web portal in accordance with the preferred embodiment of the present invention;

FIG. 7 illustrates a list of music concerts displayed on the at least one electronic device in accordance with the preferred embodiment of the present invention; and

FIG. 8 illustrates a list of tagged tracks displayed on the at least one electronic device in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address all or any of the problems discussed above or only address one of the problems discussed above. Further, one or more of the problems discussed above may not be fully addressed by any of the features described below.

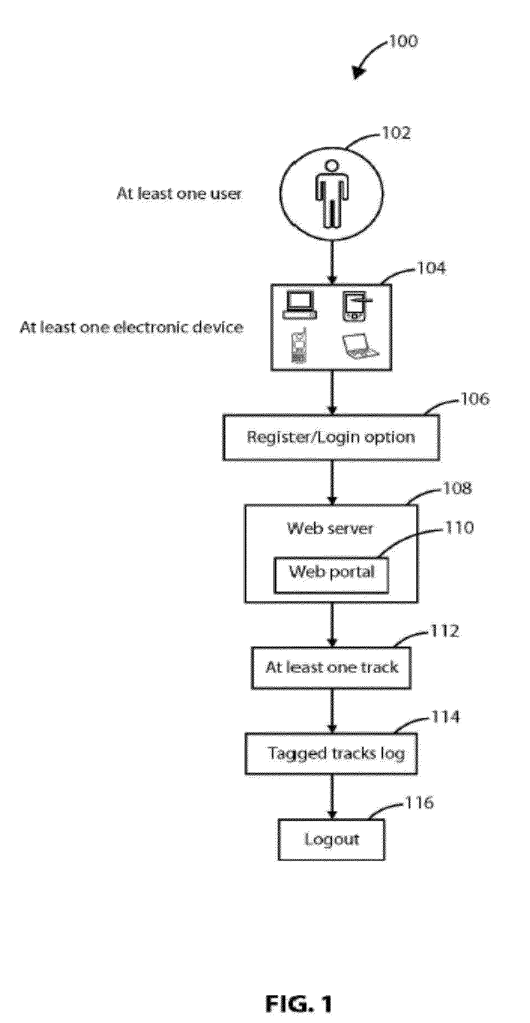

Turning first to FIG. 1, a schematic diagram of an interactive music portal system 100 for providing an enhanced live music experience to at least one user 102 in real time is illustrated. The interactive music portal system 100 comprises at least one electronic device 104 associated with the at least one user 102, a web portal 110 configured to include a plurality of web pages and a web server 108 associated with the web portal 110. The at least one electronic device 104 is capable of accessing a web browser. The web server 108 is configured to include a database of music concerts.

The at least one user 102 utilizes the web browser to access the web portal 110. The at least one user 102 may be given a register/login option 106 to log into the web portal 110 utilizing a username and a password. The web server 108 utilizes Global Positioning System (GPS) data to determine the location of the at least one user 102. The login time of the at least one user 102 is determined utilizing timestamps. The timestamps may alternatively record the access time of the at least one user 102, if the at least one user 102 is already logged in. Based on the GPS data and the timestamps, the web-portal 110 is able to determine which concert is being performed for the at least one user 102. The web server 108 compares the location and the login time of the at least one user 102 with the database of music concerts to determine in real time the at least one track 112 attended by the at least one user 102. The web portal 110 allows the at least one user 102 to instantaneously tag the at least one track 112 of at least one music concert. The at least one track 112 tagged is automatically time coded by the web portal 110 to determine which track the at least one user 102 wants to tag. The at least one user 102 may view the plurality of tracks tagged in a tagged tracks log 114. The at least one user 102 may logout from the web portal 110 by clicking on a logout button 116. At the end of the at least one music concert, the web server 108 sends a confirmation message to the at least one electronic device 104. The confirmation message includes a link of the at least one track 112 tagged by the at least one user 102. The at least user 102 may access the link in future to preview, purchase and download the at least one track 112 tagged.

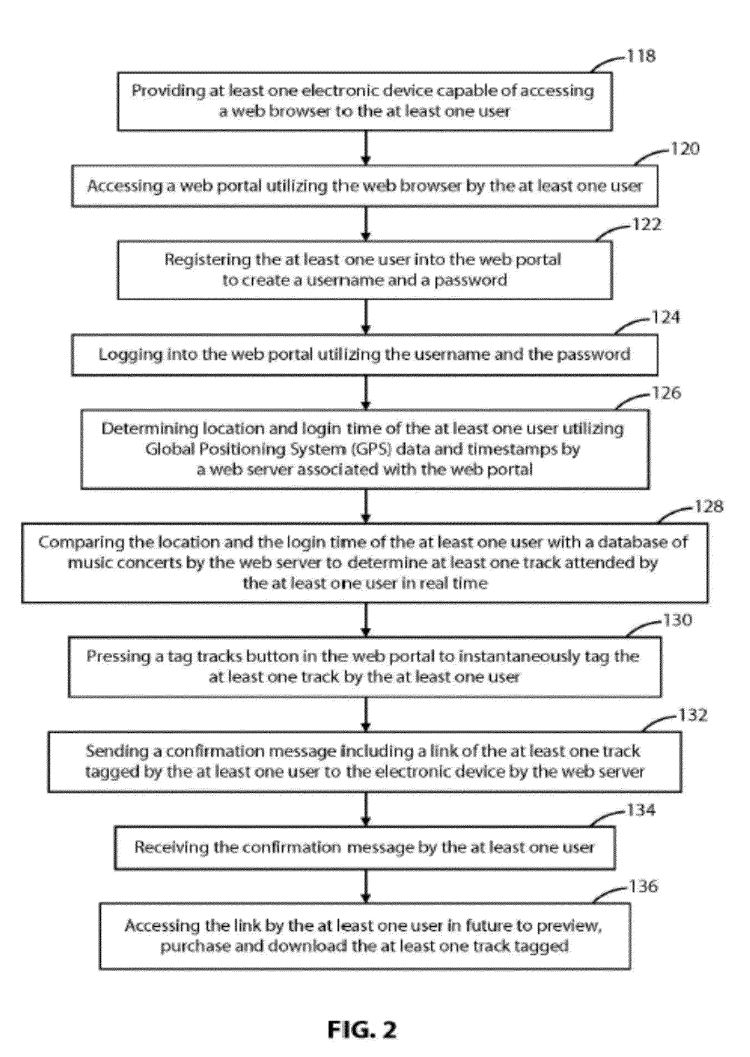

The present invention considers an interaction of the at least one user 102 with the web portal 110 to instantaneously tag the at least one track 112 in real time, thereby providing an enhanced live music experience to the at least one user 102, preferably in real time. Referring to FIG. 2, an operational flow chart of the method for providing an interactive means for the at least one user to instantaneously tag at least one track in real time is illustrated. Initially, at least one electronic device capable of accessing a web browser is provided to the at least one user as indicated at block 118. Next, a web portal is accessed utilizing the web browser by the at least one user as shown in block 120. Then, the at least one user is registered into the web portal to create a username and a password as indicated at block 122. The at least one user logs into the web portal utilizing the username and the password as shown in block 124. In this method, a web server associated with the web portal determines location and login time of the at least one user utilizing Global Positioning System (GPS) data and timestamps as indicated at block 126. The web server then compares the location and the login time of the at least one user with a database of music concerts to determine at least one track attended by the at least one user in real time as shown in block 128. In next step, the at least one user presses a tag tracks button in the web portal to instantaneously tag the at least one track as indicated at block 130. The web server then sends a confirmation message including a link of the at least one track tagged by the at least one user to the at least one electronic device as shown in block 132. The confirmation message is received by the at least one user as indicated at block 134. Finally, as shown in block 136, the at least one user may access the link in future to preview, purchase and download the at least one track tagged. The systems portal system 102 provides these features for the at least one user 102.

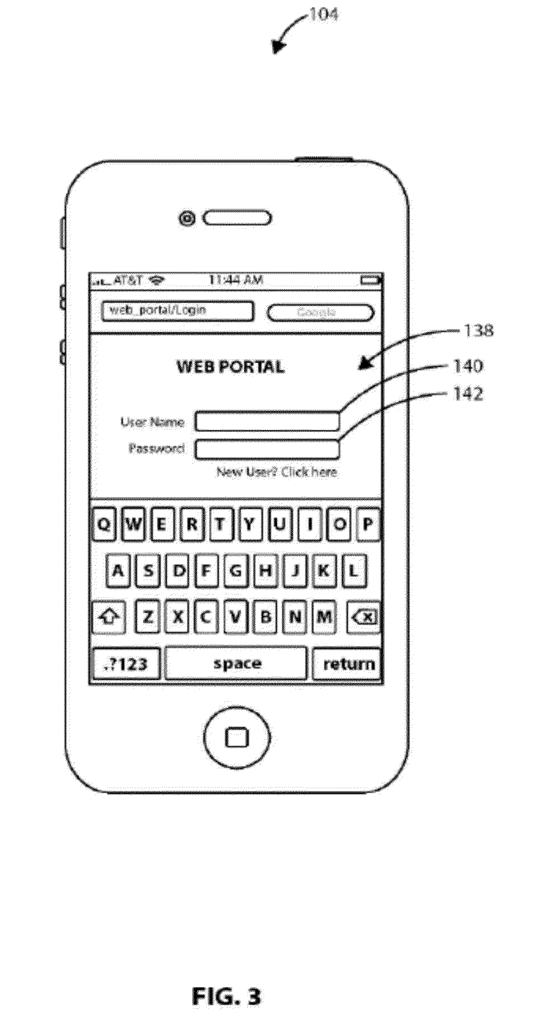

FIG. 3 illustrates the at least one electronic device 104 displaying a login page 138 of the web portal 110 in accordance with the preferred embodiment of the present invention. The at least one electronic device 104 preferably may be selected from a group consisting of: smart phones, iPhones, laptops, tablet computers, and personal computers. In alternative embodiments other devices capable of accessing the Internet and World Wide Web may be employed. In each embodiment, the at least one user 102 may utilize the web browser to access the web portal 110. See also FIG. 1. Returning to FIG. 1, when the at least one user 102 logs into the web portal 110 for the first time, the at least one user 102 may register with the web portal 110 to create a username 140 and a password 142. Henceforth, the at least one user 102 may login to the web portal 110 utilizing the username 140 and the password 142.

The web server 108 utilizes Global Positioning System (GPS) data to determine the location of the at least one user 102. The login time of the at least one user 102 is determined utilizing timestamps. Based on the GPS data and the time stamps, the web-portal 110 is able to determine which concert is being performed for the at least one user 102. The web server 108 compares the location and the login time of the at least one user 102 with the database of music concerts to determine the at least one track 112 being attended by the at least one user 102 in real time. The web portal 110 allows the at least one user 102 to instantaneously tag the at least one track 112 of at least one music concert. The at least one track 112 tagged is automatically time coded by the web portal 110 to determine which track the at least one user 102 wants to tag. The time code of the at least one track 112 may be obtained through automatic means such as song recognition software. The song recognition software utilizes the playlist of the at least one music concert to time code the at least one track 112. The song recognition software allows the at least one user 102 to tag the at least one track 112 without knowing the song name, band name or the location of the at least one music concert.

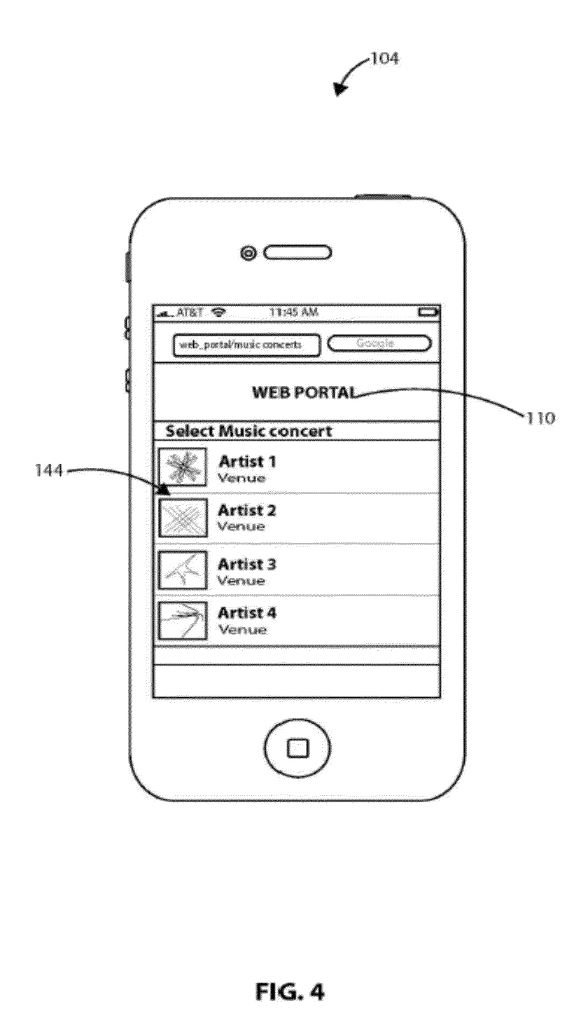

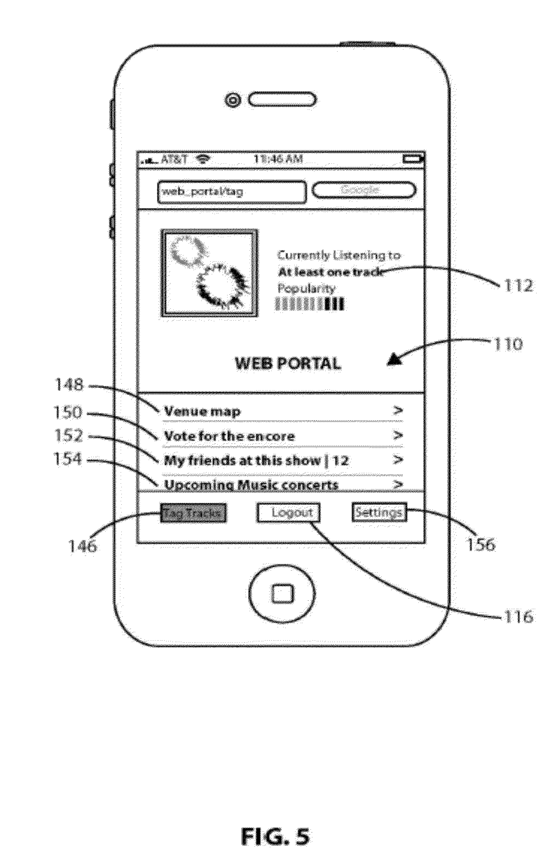

FIG. 4 illustrates the at least one electronic device 104 displaying a list of music concerts to be selected by the at least one user 102 (not shown) in accordance with the preferred embodiment of the present invention. If the location of the at least one user 102 is not available through the GPS data, the web server 108 (not shown) provides an option to manually select the at least one music concert currently attended from a list of concerts 144. The at least one user 102 may also select the location of the at least one music concert. The at least one user 102 may manually input the performance time and date of the at least one music concert in the web portal 110. The web portal 110 allows the at least one user 102 to select the at least one music concert regardless of whether the at least one user 102 attended the at least one music concert in person. The web portal 110 allows the at least one user 102 to instantaneously tag the at least one track 112 (see FIG. 5, described in more detail below) of the at least one music concert. The web portal 110 also allows the at least one user 112 to tag previous and next tracks. The interactive music portal system 100 may stream the at least one track 112 tagged to the at least one electronic device 104 after a particular time.

The at least one user 102 may access the web portal 110 by sending a text message to the web portal 110. The text message may include any of time, location and name of the at least one music concert to the web portal 110. The web portal 110 may send a link in return that allows the at least one user 102 to access the web portal 110.

FIG. 5 illustrates the at least one electronic device 104 displaying the at least one track 112 to be tagged by the at least one user 102 in accordance with the preferred embodiment of the present invention. The web portal 110 displays the at least one track 112 to be tagged by the at least one user 102. The at least one user 102 may instantaneously tag the at least one track 112 by pressing a tag tracks button 146 in the web portal 110. The tag tracks button 146 is automatically time coded by the web portal 110 to determine the at least one track 112 tagged by the at least one user 102. The at least one user 102 may view the venue of the at least one music concert using the “Venue map” option 148 provided in the web portal 110. The web portal 110 allows the at least one user 102 to vote for encore 150 to the at least one track 112. The web portal 110 shows the number of friends of the at least one user 102 present at the at least one music concert using option “My friends at this show” 152. This option may also allow the at least one user 102 to find any friends present at the at least one music concert and communicate with the friends in real-time. The at least one user 102 may access the list of the upcoming music concerts using the “Upcoming Music concerts” option 154 provided in the web portal 110. The at least one user 102 may adjust the settings of the web portal 110 by pressing the “Settings” button 156.

The at least one user 102 may logout from the web portal 110 by pressing a logout button 116. The at least one user 102 may share the at least one track 112 purchased with a limited number of friends by sharing the link containing the at least one track 112 tagged. The link may be shared through a networking means such as e-mail, text message or social networking sites such as Facebook.

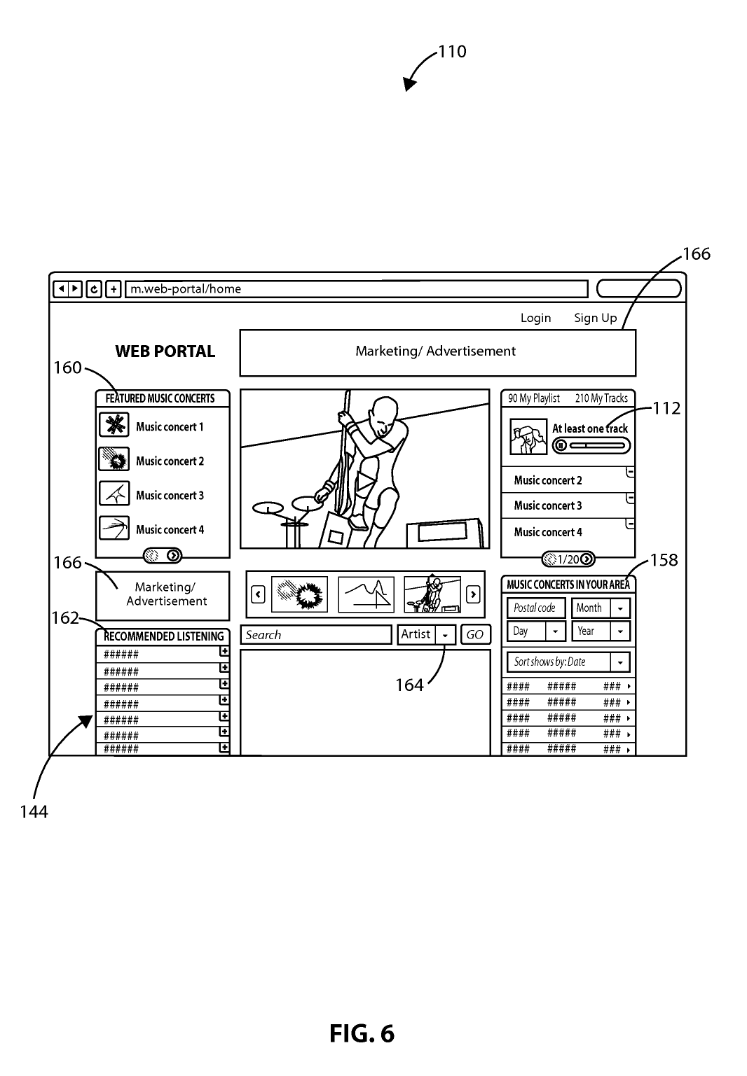

FIG. 6 illustrates the web portal 110 in accordance with the preferred embodiment of the present invention. The web portal 110 includes the plurality of web pages, which are hosted as sub pages under the web portal 110 to display information related to music concerts. The information related to music concerts may include a map of the venue, music concerts in a specific area, featured music concerts and the like. The web portal 110 allows the at least one user 102 to view the music concerts in a specific area by providing a drop-down list of music concerts in the at least one user's area 158. The at least one user 102 may view the list of music concerts by entering the details such as date, month, year and postal code in the drop-down list. The web portal 110 displays a list of featured music concerts 160 to the at least one user 102. The web portal 110 also displays the at least one track 112 attended by the at least one user 102 in real time. Depending on the list of music concerts previously attended by the at least one user 102, the web portal 110 provides a selected list of music concerts of interest 144 to the at least one user 102 by providing a recommended listening list 162.

The web portal 110 may optionally display the activity of the at least one user 102. The web portal 110 may include different groups of users such as genres or locals. The web portal 110 may also include a fans group for specific music bands. The at least one user 102 may search for tracks from the database of music concerts by entering artist name or concert name in the web portal 110 utilizing a search drop-down list 164. In addition, the web portal 110 may direct marketing and advertisements 166 that are tailored to the specific interests of the at least one user 102. The web portal 110 allows the at least one user 102 to have access to certain merchandise like: T-shirts, shot glasses and special artwork regarding the band. Further, the web portal 110 may provide a virtual corkboard for the at least one user 102 wherein the at least one user 102 may digitally post the ticket of the at least one music concert. The at least one user 102 may utilize the virtual representation of the ticket on the virtual corkboard to retrieve information about the at least one music concert.

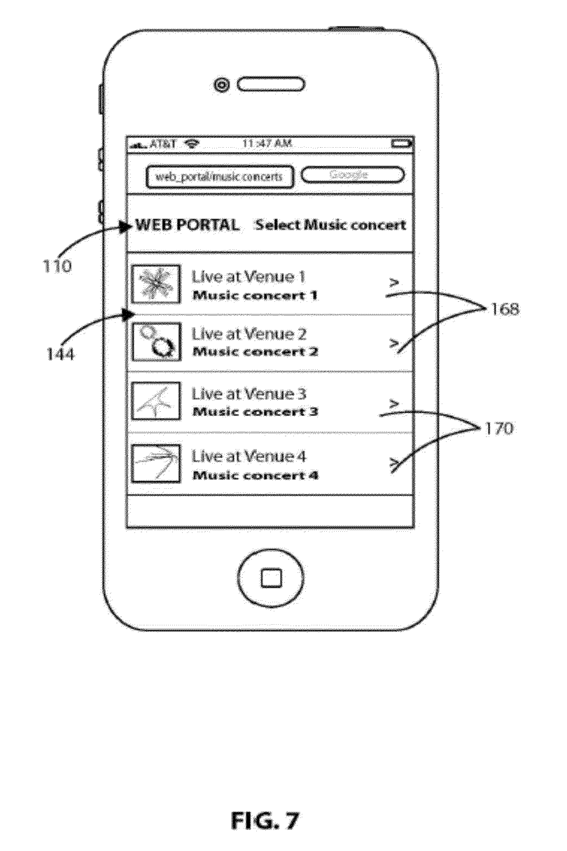

FIG. 7 illustrates a list of music concerts displayed on the web portal 110 in accordance with the preferred embodiment of the present invention. The at least one user 102 may view the list of music concerts 144 along with the venue and time. The web portal 110 displays the list of live music concerts 168 and upcoming music concerts 170 to the at least one user 102. The web portal 110 allows the at least one user 102 to tag the at least one track 112 (not shown) never attended. The at least one user 102 may also purchase the entire music concert by tagging the entire music concert. The web portal 110 grants special access to the at least one user 102 who attended the at least one music concert to preview, purchase or download tracks in addition to the at least one track 112 tagged by the at least one user 102.

In certain other embodiments the at least one user 102 need never physically attend the live music concert. Instead, the at least one user 102 may simply access the web portal 110, and select a concert from a list of live music concerts 168, as described above. In short the user may begin the process at FIG. 5. Alternatively, the user may access one concert from the list of live music concerts 168 by clicking a link provided via an electronic message to the at least one user 102.

In yet other embodiments the web portal 110, whether accessed by a user who attended a concert or not, may provide to the user a list of the most popular tracks tagged and/or downloaded by other users.

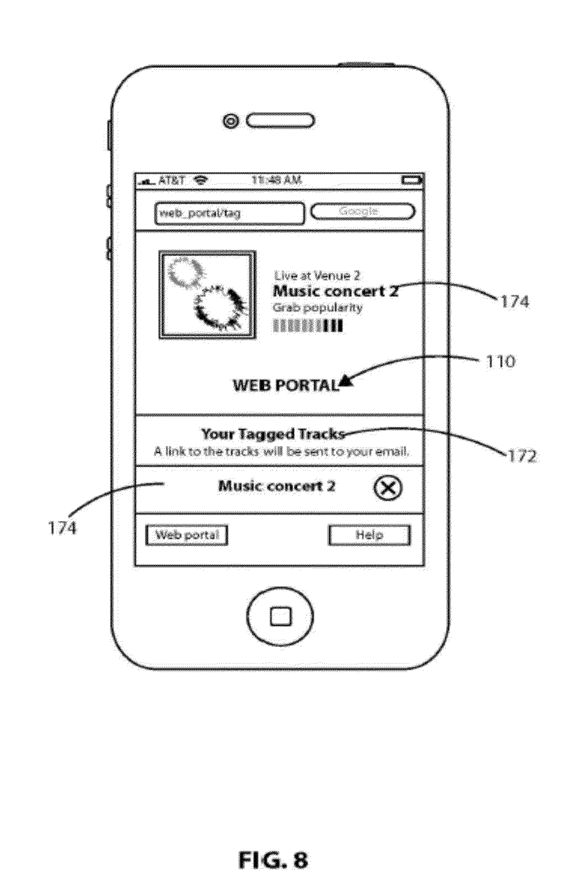

FIG. 8 illustrates a list of tagged tracks displayed on the web portal 110 in accordance with the preferred embodiment of the present invention. The web portal 110 displays a message 172 to the at least one user 102 showing the list of tagged tracks. For instance, the at least one user 102 selects “Music Concert 2” from the list of live music concerts 168. The at least one user 102 then tags the “Music Concert 2” 174. The web portal 110 displays the “Music Concert 2” 174 tagged by the at least one user 102 and sends a confirmation message to the at least one electronic device 104. The confirmation message includes a link containing the “Music Concert 2” 174 tagged by the at least one user 102. The confirmation message may be selected from a group consisting of: text messages, multimedia messages, twitter messages, Facebook messages, e-mails and the like. The at least one user 102 may preview, purchase and download other tracks from the same concert or at least one track 112 from the database of music concerts.

In an alternate embodiment of the present invention, the at least one user 102 may utilize an application software installed on the at least one electronic device 104 to access the web portal 110. In yet another embodiment, the music portal system 100 may be used for tagging any media selected from a group consisting of: movie previews, TV shows and the like. For instance, the at least one user 102 may tag a movie preview to purchase a DVD copy or soundtrack of the movie.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the appearance of the web portal 110 may be different depending on the display and the designing tools of the at least one electronic device 104. It is intended that the scope of the present invention not be limited by this detailed description, but by the claims and the equivalents to the claims appended hereto.

I claim:

1. An interactive music portal system for providing an enhanced live music experience to at least one user in real time, the system comprising:
at least one electronic device associated with the at least one user, the at least one electronic device being capable of accessing a web browser;
a web portal configured to include a plurality of web pages, the web portal being accessed by the at least one electronic device utilizing the web browser; and
a web server associated with the web portal, the web server being configured to reference a database of music concerts;
whereby the web portal allows the at least one user to instantaneously tag at least one track of at least one music concert to preview, purchase and download the at least one track utilizing the at least one electronic device in real time.

2. The system of claim 1 wherein the at least one user utilizes the web browser to access the web portal.

3. The system of claim 1 wherein the web server utilizes Global Positioning System (GPS) data to determine location of the at least one user.

4. The system of claim 3 wherein the web server utilizes timestamps to determine login time of the at least one user.

5. The system of claim 3 wherein the web server compares the location and the login time of the at least one user with the database of music concerts to determine the at least one track attended by the at least one user in real time.

6. The system of claim 1 wherein the web server utilizes timestamps to determine login time of the at least one user.

7. The system of claim 1 wherein the at least one user may instantaneously tag the at least one track by pressing a tag tracks button in the web portal, and wherein said tag tracks button is automatically time coded by the web portal to determine the at least one track tagged by the at least one user.

8. The system of claim 1 wherein the web server sends a confirmation message to the at least one electronic device, and wherein said confirmation message may include a link containing the at least one track tagged by the at least one user.

9. The system of claim 8 wherein the at least one user may access the link in future to preview, purchase and download the at least one track tagged.

10. The system of claim 1 wherein the plurality of web pages are hosted as sub pages under the web portal to display information related to music concerts.

11. The system of claim 10 wherein the information related to music concerts may include a map of the venue, music concerts in a specific area and featured music concerts.

12. The system of claim 1 wherein the web portal may allow the at least one user to vote for an encore to the at least one track.

13. The system of claim 1 wherein the system allows the at least one user to find friends present at the at least one music concert in real time, and wherein the at least one user may communicate with said friends utilizing the web portal in real time.

14. The system of claim 1 wherein the web portal may allow the at least one user to purchase and download a plurality of tracks from the database of music concerts.

15. The system of claim 1 wherein the web portal provides a virtual corkboard for the at least one user to digitally post the ticket of the at least one music concert, and wherein said virtual corkboard may be used to retrieve information about the at least one music concert.

16. A method for providing an enhanced live music experience to at least one user in real time, the method comprising the steps of:
a) providing at least one electronic device capable of accessing a web browser to the at least one user;
b) accessing a web portal utilizing the web browser by the at least one user;
c) registering the at least one user into the web portal;
d) determining location and login time of the at least one user utilizing Global Positioning System (GPS) data and timestamps by a web server associated with the web portal;
e) comparing the location and the login time of the at least one user with a database of music concerts by the web server to determine at least one track attended by the at least one user in real time;
f) pressing a tag tracks button in the web portal to instantaneously tag the at least one track by the at least one user;
g) sending a confirmation message to the electronic device by the web server, the confirmation message configured to include a link containing the at least one track tagged by the at least one user;
h) receiving the confirmation message by the at least one user; and
i) accessing the link by the at least one user to preview, purchase and download the at least one track tagged.

17. The method of claim 16 wherein the web portal is configured to include a plurality of web pages hosted as sub pages to display information related to music concerts.

18. The method of claim 17 wherein the information related to music concerts may include a map of the venue, music concerts in a specific area and featured music concerts.

19. The method of claim 16 wherein the tag tracks button is automatically time coded by the web portal to determine the at least one track tagged by the at least one user.

20. The method of claim 16 wherein the web portal may allow the at least one user to vote for an encore to the at least one track.
